(19) United States
(12) Patent Application Publication
(10) Pub. No.: US 2025/0378503 A1
(43) Pub. Date: Dec. 11, 2025

(54) METHOD AND SYSTEM FOR PROVIDING FEE INFORMATION ASSOCIATED WITH BROKERAGE ACCOUNTS AND TAX RETURNS AND PROVIDING SENTIMENT SCORES FOR ALTERNATIVE PORTFOLIO HOLDINGS

(71) Applicant: Clarifees LLC, Omaha, NE (US)

(72) Inventors: Ryan Morrison, Omaha, NE (US); Kyle McCormick, Omaha, NE (US)

(21) Appl. No.: 19/069,217

(22) Filed: Mar. 4, 2025

Related U.S. Application Data
(63) Continuation-in-part of application No. 18/735,169, filed on Jun. 5, 2024.

(51) Int. Cl. G06Q 40/10; G06Q 40/06

(52) U.S. Cl. CPC G06Q 40/10; G06Q 40/06

(57) ABSTRACT

A method and system for investing in securities, equities, and funds is currently provided. The method comprises a client selecting at least one security, equity, or fund from their current holdings, comparing their selection with other available securities, equities, and funds in a database and calculating a sentiment score for each of the compared alternatives. The sentiment score is a calculated likeness between, or an inverse distance from, the client's selection and the compared securities, equities, or funds. The compared securities, equities, or funds are ranked by their sentiment scores and an expense ratio, a 12b-1 fee, and a front load fee associated with at least an upper ranked portion of the compared securities, equities, or funds is reported.

### CROSS REFERENCE TO RELATED APPLICATIONS

This application claims priority to U.S. application Ser. No. 18/735,169, filed Jun. 5, 2024, which claims priority to U.S. application No. 63/517,923, filed Aug. 6, 2023, the disclosures of which are hereby incorporated by reference in their entirety.

### FIELD OF THE DISCLOSURE

The present disclosure generally relates to methods and systems for maximizing returns to the client or customer with investment accounts, particularly methods and systems for providing fee information associated with holdings in brokerage accounts and sentiment scores for alternative portfolio holdings with lower fees, allowing the client to save money on fees and reinvest into their brokerage accounts.

### BACKGROUND

Investment accounts are financial tools that individuals use to invest their money in various assets such as stocks, bonds, mutual funds, exchange-traded funds (ETFs), and more. These accounts serve as containers for holding and managing investments, allowing individuals to grow their wealth over time.

Brokerage accounts are general-purpose accounts offered by brokerage firms where investors can buy and sell a wide range of investments. Brokerage accounts can be taxable or tax-advantaged, such as individual brokerage accounts (taxable) and IRAs (Individual Retirement Accounts).

An advisor, or even a robo-advisor, may manage investment accounts. Managed accounts typically have professionals manage their investments on their behalf. Managed accounts are typically offered by brokerage firms or financial advisory firms, where investment professionals make investment decisions based on the investor's goals, risk tolerance, and preferences.

Mutual funds may be similar to a managed investment account as they have funds pooled together and managed by professional portfolio managers or investment management companies. A mutual fund is a type of investment vehicle where funds from multiple investors are pooled together to invest in a diversified portfolio of securities, such as stocks, bonds, money market instruments, or a combination of these assets.

Investment accounts and mutual funds are managed by advisors, investment managers, portfolio managers, or other professional managers responsible for selecting the securities to be included in the portfolios. These advisors or managers typically conduct research, analyze market trends, and make investment decisions to achieve the fund's objectives. Investment accounts and mutual funds vary in features, fees, and tax implications. These variations may be challenging for an investor or even an advisor to determine, thus making it challenging to maximize the return of investments.

### SUMMARY

In one aspect of the present disclosure, a method for investing in securities, equities, and funds is provided. The method comprises: receiving an invitation to join an investing system, by a customer; accepting the invitation, establishing an account with the investing system, and transmitting a portfolio of current holdings of securities, equities, or funds to the system, by the customer; selecting at least one security, equity, or fund from their current holdings, by the customer; comparing the customer's selected at least one selected security, equity, and fund with other available securities, equities, and funds in a database and calculating a sentiment score for each of the compared securities, equities, and funds in the database, by the system; wherein the sentiment score for each of the compared securities, equities, and funds is calculated by determining a percentage of likeness with, or an inverse of a Euclidean distance from, the customer's selected at least one selected security, equity, and fund and the compared securities, equities, or funds in the database; ranking the compared securities, equities, or funds by their calculated sentiment scores, by the system; and compiling and transmitting, an expense ratio, a 12b-1 fee, and a front load fee associated with at least an upper ranked portion of the compared securities, equities, or funds.

In another aspect of the present disclosure, an investing system configured to perform the steps of the method is provided. The system comprises a sentiment & fee comparison engine configured and disposed for determining the percentage of likeness with, or the inverse of a Euclidean distance from, the customer's selected at least one selected security, equity, or fund and the compared securities, equities, and funds in the bank or brokerage database, a customer database configured to receive and store the customer's data and the transmitted portfolio of the customer's current holdings of securities, equities, and funds, a predictive modeling engine configured for the modeling of the cost savings of the upper ranked portion of the compared securities, equities, and funds over the period of time, and a portfolio and fee reporting engine configured for the compiling and transmitting the expense ratio, 12b-1 fee, and the front load fee.

In further aspect of the present disclosure, an investing system configured for providing fee information associated with brokerage accounts and providing sentiment scores for alternative portfolio holdings is provided. The system is configured for: receiving an invitation to join an investing system, by a customer; accepting the invitation, establish an account with the investing system, and transmitting, or initiating a transmission of, a portfolio of current holdings of securities, equities, and funds to the system, by the customer; selecting at least one security, equity, or fund from their current holdings, by the customer; comparing the customer's selected at least one selected security, equity, or fund with other available securities, equities, and funds in a bank or brokerage database and calculating a sentiment score for each of the compared securities, equities, and funds in the database, by the system; wherein the calculating of the sentiment score for each of the compared securities, equities, and funds is performed by determining a percentage of likeness with, or an inverse of a Euclidean distance from, the customer's selected at least one selected security, equity, or fund and the compared securities, equities, and funds in the bank or brokerage database; ranking the compared securities, equities, and funds by their calculated sentiment scores, by the system; and compiling and transmitting, an expense ratio, a 12b-1 fee, and a front load fee associated with at least an upper ranked portion of the compared securities, equities, and funds.

### BRIEF DESCRIPTIONS OF THE DRAWINGS

The foregoing and other features of this disclosure will become more fully apparent from the following description and appended claims, taken in conjunction with the accompanying drawings and examples. Understanding that these drawings depict only several embodiments following the disclosure and are, therefore, not to be considered limiting of its scope, the disclosure will be described with additional specificity and detail through the use of the accompanying drawings, in which:

FIG. 1 shows a schematic illustration of the presently disclosed system;

FIG. 2 shows an embodiment of an advisor interface that may be provided with the presently disclosed system;

FIG. 3 shows a flow chart for exchanging tokens and Open Banking API used to data aggregate through user permission based on the lead or client giving consent to pull the data after logging into their brokerage account;

FIG. 4 shows the advisor how to connect their current financial customer relationship management system, CRM,within the system;

FIG. 5 shows the advisor how to create a tag in their financial CRM for sending an invitation to a customer;

FIG. 6 shows how to tag a contact using Smartleads™ for sending an invitation to a customer;

FIG. 7 shows the system providing fee information of holdings associated with brokerage accounts with the Smartfees™ portion of the system;

FIG. 8 shows the QR code and link Smartleads™ provides the advisor to allow leads to access the screen to connect their accounts;

FIG. 9 shows the client or lead-facing screen to fill out their contact information and connect their accounts to the presently disclosed system;

FIG. 10 shows an embodiment of a user interface that may be provided with the presently disclosed system;

FIG. 11 shows calculated sentiment scores for a customer's selected security or fund(s) and associated fees;

FIGS. 12-16 show steps taken by a customer or client for establishing an account and verifying their identity with the investing system; and

FIGS. 17-21 show a reporting of capital gains tax.

### DETAILED DESCRIPTION

In the following detailed description, reference is made to the accompanying drawings, which form a part hereof. In the drawings, similar symbols typically identify similar components unless context dictates otherwise. The illustrative embodiments described in the detailed description, drawings, and claims are not meant to be limiting. Other embodiments may be utilized, and other changes may be made without departing from the subject matter's spirit or scope. It will be readily understood that the aspects of the present disclosure, as generally described herein and illustrated in the figures, can be arranged, substituted, combined, separated, and designed in various configurations, all explicitly contemplated herein.

Presently disclosed are systems and methods for maximizing returns with investment accounts. In individual investment accounts, there currently needs to be more efficient way to determine what fees an individual pays to their financial advisors, account managers, and brokerage. There may be hidden fees, and even if the fees are locatable and labeled, determining how the fees are being derived and applied may need to be clarified, especially for individuals who work outside of the financial sector.

Aspects of the present disclosure provide a method and system for aggregating the various fees that an individual is charged by various financial planners or managers and presenting the fees clearly and concisely. This may provide a tool for an individual or advisor to identify the fees they are paying and how those fees are being applied. Another aspect of the present disclosure is to analyze past fees paid as compared to the fees that they would have been paid to different financial planners or advisors. A further aspect of the present disclosure may provide for predicting and comparing future fees paid with their current financial planner to other financial providers available to the investor.

The present disclosure relates generally to methods and systems for analyzing individual investment fees as they are related to investment portfolios, analyzing past performances, and predicting future performance of the investment portfolios. The presently disclosed system may allow a customer of an investment firm to compare and contrast the fees they're paying on their investment accounts. The comparison of fees may include past, future, or both for the user to determine which investment firms provide the lowest fees on the user's investment accounts or on comparable alternative investments.

It is noted that any reference herein to “one embodiment” or “an embodiment” means that a particular feature, structure, or characteristic described in connection with the embodiment is included in at least one embodiment of the disclosure. The appearances of the phrase “in one embodiment” in various places in the specification do not necessarily refer to the same embodiment.

As used herein, assets, rights, or liabilities refer to any investable item or tradable commodity, instrument, or item of value in which a market exists for trading. This definition includes securities, equities, derivatives, currencies, fungible commodities, insurance contracts, mortgages, bonds, airline reservations, hotel reservations, golf tee times, country club memberships, antiques, etc. Manager or financial manager shall refer to someone who oversees or is responsible for investing a fund's assets, implementing an investment strategy, managing mutual funds, or performing similar functions for an investor. Advisor or financial advisor shall refer to someone who provides financial services or guidance to clients, customers, or individual investors. The terms manager, financial manager, advisor, and financial advisor may be used interchangeable throughout the description. The terms client, customer, and user refer to the individual having ownership of the commodities or instruments linked with the system and are considered interchangeable throughout the description.

The term “smartdata” TM is the name of the presently disclosed system for providing fee information associated with brokerage accounts and providing sentiment scores for alternative portfolio holdings. The term fintech refers to systems and other technologies used to support or enable banking and financial services. The term “smartfees” TM refers to a portfolio and fee reporting engine or a method and report provided by the system to the advisor or client that shows the current holdings all the fees in those holdings. The term “smartleads” TM refers a quick-response, QR, code or link, or method of generating and sending the QR code or link, an advisor may put on their website or on a business card to allow the client or lead to enter in their information and connect their account with the system or Smartdata™.

Although the computer-based system of the present disclosure may be used concerning any asset or liability traded or invested, the disclosure herein may relate primarily to its use in connection with securities and instruments (Ex. stocks, mutual funds, or bonds) for simplicity purposes.

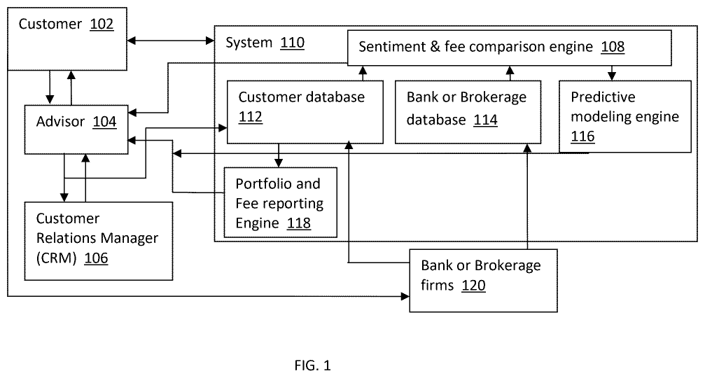

FIG. 1 shows a schematic illustration of the presently disclosed system 110, which may be referred to as Smartdata™. System 110 has sentiment & fee comparison engine 108 in communication with customer database 112, bank or brokerage database 114, predictive modeling 116, and portfolio and fee reporting 118. Bank or brokerage firms 120 may be in communication with system 110. For example, bank or brokerage firms 120 may in communication with brokerage database 114 and customer database 112. A customer 102 may be in communication with system 110 advisor 104. Advisor 104 may be in communication with customer 110, system 110, and CRM 106.

In at least one embodiment of the present disclosure, system 110 is configured to receive a customer's 102 acceptance to join system 110 and establish an account for customer 102 by receiving and saving customer's 102 data in customer database 112. System 110 may then receive customer's 102 initiation of a transmission of a portfolio of current holdings of securities, equities, or funds and save the information in customer database 112. System 110 may be configured to receive a selection of at least one security, equity, or fund from their current holdings by customer 102. System 110 may be configured for comparing customer's 102 selection of at least one security, equity, or fund with other available securities, equities, and funds in bank or brokerage database 114, and calculating a sentiment score, with sentiment & fee comparison engine 108, for each of the compared securities, equities, and funds. For example, sentiment & fee comparison engine 108 may be configured to calculate a percentage of likeness with, or an inverse of a Euclidean distance from, the customer's selected at least one selected security, equity, or fund and the compared securities, equities, and funds in the database. System 110 may be configured to rank the compared securities, equities, and funds by their calculated sentiment scores and compile and transmit an expense ratio, a 12b-1 fee, and a front load fee associated with at least an upper ranked portion of the compared securities, equities, and funds.

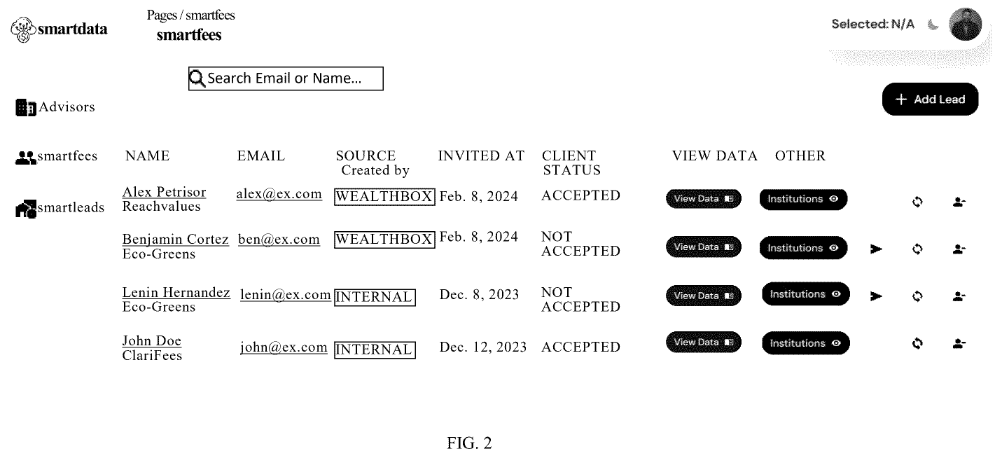

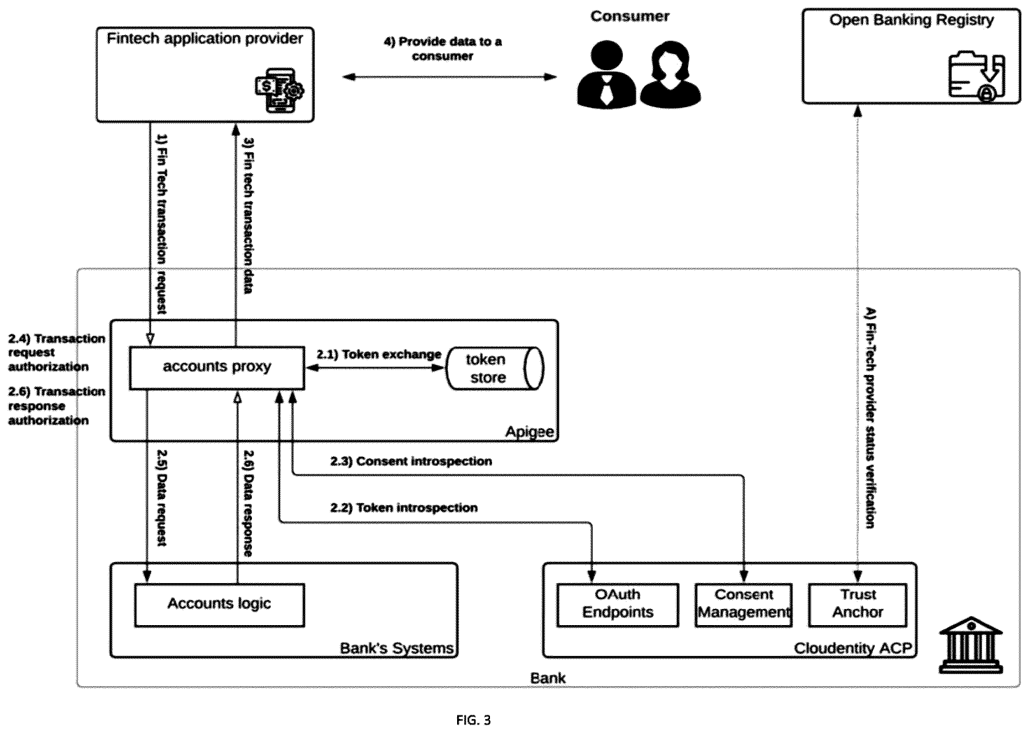

FIG. 2 shows an embodiment of an advisor interface that may be provided with the presently disclosed system. For example, the system, Smartdata™, may be configured to transmit a report, Smartfees™, notifying an advisor of the status of potential customers that have been sent an invitation. In at least one embodiment, the report comprises identifying information of the potential customers, the source or invitation sender identifier such as the system or the advisor's CRM such as wealthbox, and the potential customer's status of whether or not they have accepted their invitation. FIG. 3 shows an example flow chart for exchanging tokens and Open Banking API used to data aggregate through user permission based on the lead or client giving consent to pull the data after logging into their brokerage account.

Aspects of the present disclosed system provide for customer relationship management, CRM, and functionality. CRM functionality may aid the presently disclosed system with integration and management of data and facilitate group communications. For example, a CRM such as Smartleads™ may be integrated with the presently disclosed system, providing a collaborative work management platform.

In at least one embodiment, the system is configured for a financial advisor to send an invite by clicking an “add a prospect” button and typing in the prospect's name, email, phone, address, and any other pertinent information, such as the company name. Alternatively, an invite may be sent using an existing advisor's CRM software, where the contact's data is stored. For example, an advisor may connect their CRM so that the system can pull data and automatically invite prospective users. Additionally, the system may be configured to provide advisors a link or a QR code for prospects that may invite themselves from a website, brochure, or commercial. Upon the prospective user following the supplied link, the system may prompt them to enter their name and then link their account.

In at least one embodiment, the presently disclosed system may be configured to invite a prospective lead to set up an account for enrolling with the presently disclosed system. For example, a financial advisor may tag a contact or lead in their current financial CRM using the tag “smartleads”, to initiate the workflow.

Upon being tagged, the system may automatically pull the tag and initiate the invite for the prospective customer. Additionally, an advisor may manually add a potential customer to send an invitation to the system. Further, an advisor may send an invitation to enroll with the system.

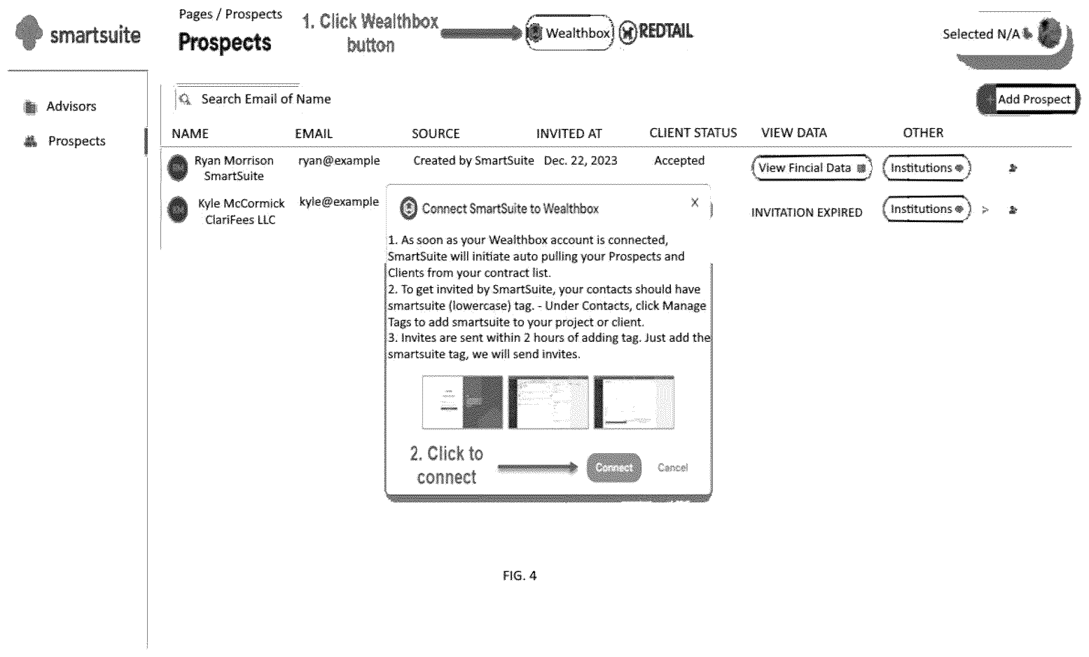

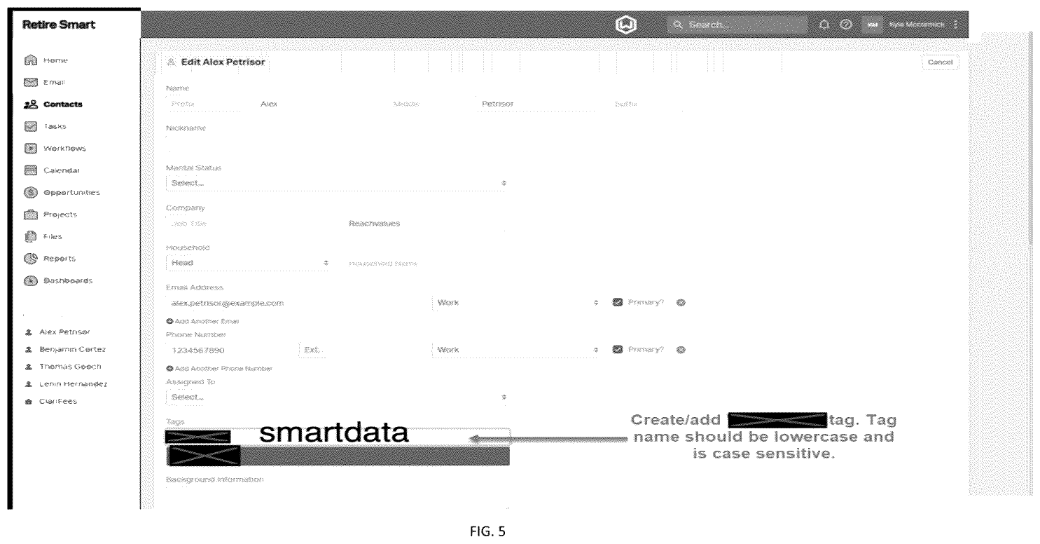

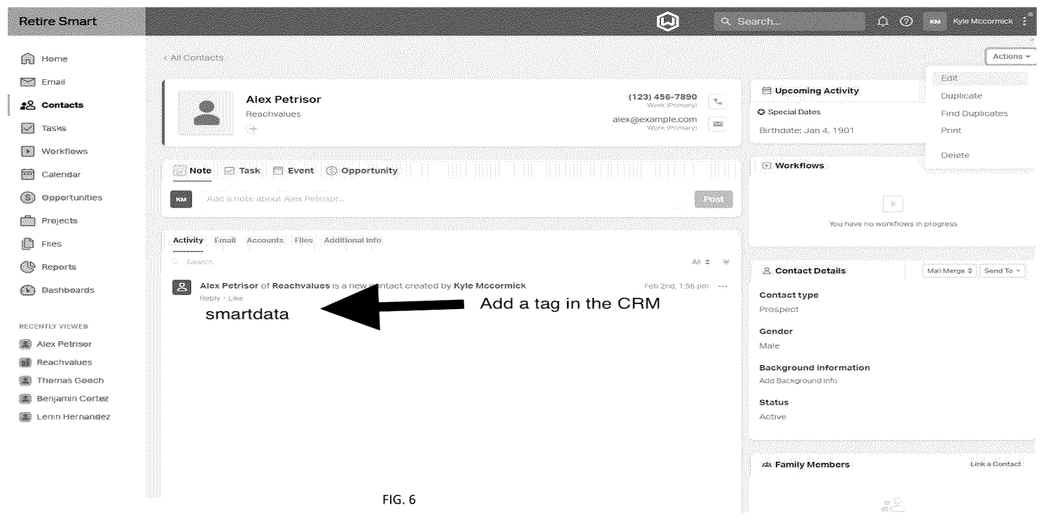

FIG. 4 shows the advisor how to connect their current financial customer relationship management system, CRM, within the system. For example, upon an advisor connecting their financial CRM, such as wealthbox, Smartdata™ may be configured to initiate automatic pulling of the advisor's prospects and clients from their contact list. In at least one embodiment, the system may be configured to send an invite to a customer simply by adding a tag, such as “smartdata”, to the project or client. For example, FIG. 5 shows how an advisor may create a tag in their financial CRM such as wealthbox for sending an invitation to a customer. FIG. 6 shows how to tag a contact using Smartleads™ for sending an invitation to a potential customer.

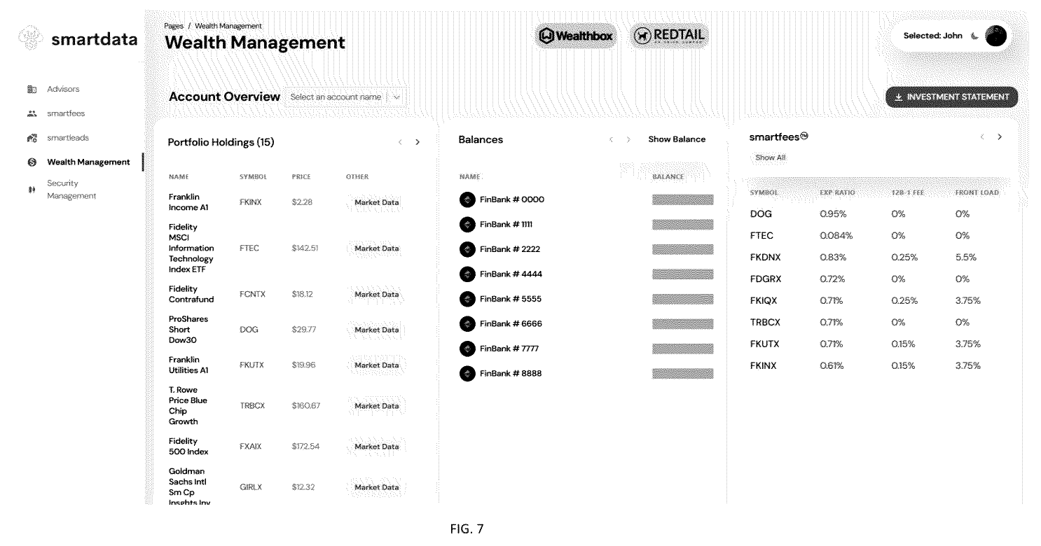

FIG. 7 shows the system providing fee information of holdings associated with brokerage accounts with the Smartfees™ portion of the system;

The front-end load is a sales charge or commission that the customer or investor pays upfront or upon purchase. The expense ratio or fees are monies paid to the brokerage and advisor. The expense ratio is a fee paid per year that is a percent of the overall portfolio value. The 12b-1 fee is an annual marketing expense. The expense ratio and the 12b-1 fee are both paid over time.

The present disclosure may provide a system and method for identifying and presenting information such as fees associated with investments. Aspects of the present disclosure may utilize an application programming interface, API, such as Open Banking API, to gather the information from an individual's existing portfolios. For example, an API such as Open Banking API may provide a platform for facilitating connections between financial institutions and third-party applications, which may provide secure access to and use of banking and financial data. The important distinction of this data aggregation is “user permission,” because the lead is connecting their account using their credentials. Therefore, they are giving the system permission to pull the data.

Upon linking the accounts, the system pulls the customer's investment data from the investment firm's transaction database, which may be any and all information related to the investment account(s). The system may then pull the fees associated with the account. The system may be configured to parse fee information from the raw fee information and categorize the fees based on administration, legal, compliance, and trade information. The system may use the fee categories to allow a user to filter out which types of fees they want to see and which fees they don't want to see. The filtering may be a single fee type, or the filtering may select multiple fee types simultaneously.

Upon receiving a customer's statements, transactions, holdings, and balances, the system identifies and categorizes all of the fees associated with each of the customer's holdings. For example, the system may be configured to correlate the fees associated with the customer's accounts with real-time market data. In at least one embodiment, all fees, including expense ratio, 12b-1 fees, front load fees, hidden fees, etc., are correlated and reported. Hidden fees may be fees that are not readily ascertainable from a broker's standard reporting, such as front-loaded fees and wrapped fees which are often times undisclosed to the client and have to be found manually by the client by reading a long disclosure statement or calling the customer service phone number. The front-end load fee is a sales charge or commission that the customer or investor pays upfront or upon purchase. The expense ratio or fees are monies paid to the brokerage and advisor. The expense ratio is a fee paid per year that is a percent of the overall portfolio value. The 12b-1 fee is an annual marketing expense. The expense ratio and the 12b-1 fee are both paid over time.

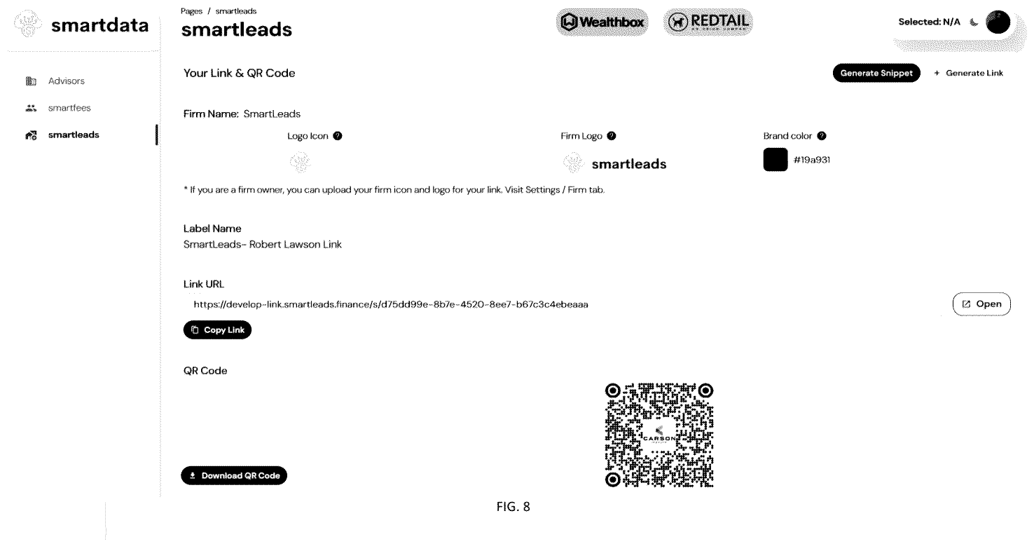

FIG. 8 shows the QR code and link Smartleads™ provides the advisor to allow leads to access the screen to connect their accounts. The system may be configured for the advisor to use a QR code or link, provided to them in the system for a lead to scan the QR code or link and initiate the workflow on connecting their account. Once the perspective customer receives an invitation and enrolls in response to the invitation, they may link their existing brokerage account(s) with the system, with an API, for example. Upon the customer linking their existing brokerage account(s) with the system, the system pulls the statements, transactions, holdings, and balances. It creates their portfolio along with the fees associated with those holdings.

For the system app server to access the information on the investment firm servers, the customer, using a customer device, sends a request to the API or Open Banking API for a link token, which is then sent to the app server. The link token request may include, but is not limited to, user IDs, passwords, PINs, IP addresses, MAC addresses, and device IDs. The information being transferred between the devices and servers may preferably be Advanced Encryption Standard (AES 256) and Transport Layer Security (TLS) security protocols. Still, any current or future encryption may also be used.

FIG. 8 shows how a customer then initializes the connection between the customer device and the app servers using the link_token. If the initialization is complete, the public_token is sent to the app server. Using the public_token, the user can log into the app server. The app server then sends the public_token to the API, which returns a static access_token to the app server. The app server then uses the access_token to securely request information from the investment servers and provide the requested information to the app server. The requested information may then be categorized and aggregated to transmit to the customer device. The static access_token may be permanently assigned or a token that needs to be renewed after a certain period of time, periodically, or every time the information is requested.

Upon the presently disclosed system gathering the investor's portfolio information, it may summarize and/or categorize the fees that individuals or investors are being paid to the individual's financial planner, manager, or advisor and present this information to the user in a simple and concise manner. The fees may include fees that the individual may easily identify, fees that the individual is not aware of, or hidden fees.

The presently disclosed system may be configured to create a data sheet for the individual and promptly show the fees they have paid in the past and potential fees they may pay in the future. This data sheet may be configured to show the fees the individual may pay to other financial advisors or managers of similar services or assets. The investor or their advisor may analyze the data in the datasheet to make a determination of whether it would be better to switch to another financial planner or other securities or instruments if they discover that they may save money in the future on fees.

In at least one embodiment, the data and information presented to the user by the system may be used to create a predictive model for determining how much in fees the individual may pay their financial planner in the future. The future window may be configured to present information for almost any time in the future, for example, from a single year up to 50 years in the future. Future predictions may be made for the fees paid to alternative financial planners or instruments, and these predictions may be compared to the predicted future fees for their current financial planner. This comparison may be used to inform the individual as to potential savings in the future depending on which financial planner or instruments the individual chooses.

The present disclosure system may be configured to provide predictive modeling to predict and show how much in fees the individual may pay their financial planner in the future. Future predictions may also be made for the fees paid to alternative financial planners for similar assets. These predictions may be compared to the predicted difference in future fees for their current financial planner compared to alternative advisors or planners. This comparison may be used to inform the individual about potential future savings depending on which financial planner the individual chooses.

Aspects of the present disclosure approach the challenge of analyzing the past and predicting the future performance of an investment portfolio based on the fees being charged to the customer. An API, such as Open Banking API, may be used to aggregate the information from the customer's investment account websites and present it to the customer in an easy-to-understand format.

The categorized information may then be displayed to the customer to show whether their fees are above or below the industry average. The frequency and timing information, specifically how many trades were completed in the investment account, for the fees may be viewable using a link on the general fee information page. The averages may be computed using a moving window or a fixed time period, which the user may automatically set or select. The averages may be based on past data, predicted future data, or a combination of the two. The averages may be any amount of time in the past from when the account was created, to any amount of time in the future. For example, the fees may be 1, 5, 10, 25, 50 years, or any time the user desires.

The predicted future fee data may be generated based on a windowing average, that takes the amount of time the user wants to be analyzed, and then dividing the past fees during that window by the amount of time, then multiplying that average by the amount of time that the user wants to be predicted into the future. The system may be configured to use machine learning to analyze past fee data and extrapolate future fees.

Past and future fee data may be displayed in any manner in which financial information is provided to a user. This may include, but is not limited to, bar graphs, line graphs, pie charts, 3D graphs, or interactive graphs with a sliding window selected automatically or manually by the user. The system may also use the fee data from other investment groups to analyze the current fees the user is paying by comparing those fees to those the user would have paid to the other investment groups. The comparison may be displayed to a user via the graphs being overlaid over each other, placed side by side or one on top of the other, or any other way so that a user can quickly compare the differences in the fees.

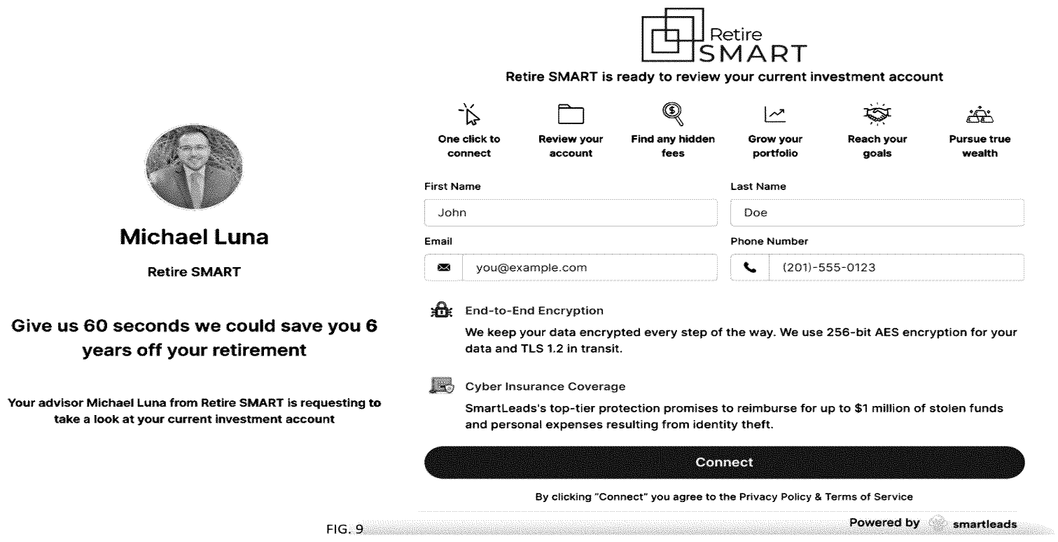

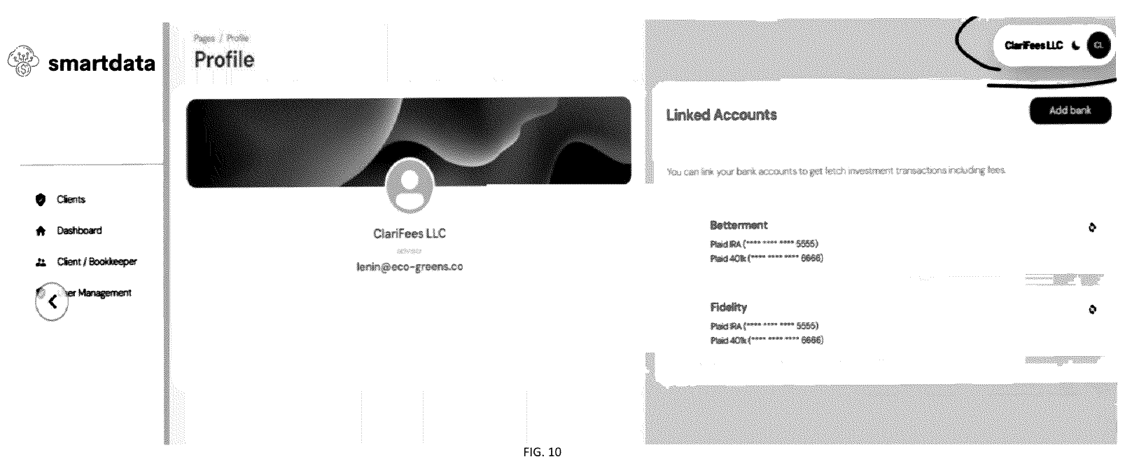

FIG. 9 shows the client or lead-facing screen to fill out their contact information and connect their accounts to the presently disclosed system and FIG. 10 shows an embodiment of a user interface that may be provided with the presently disclosed system.

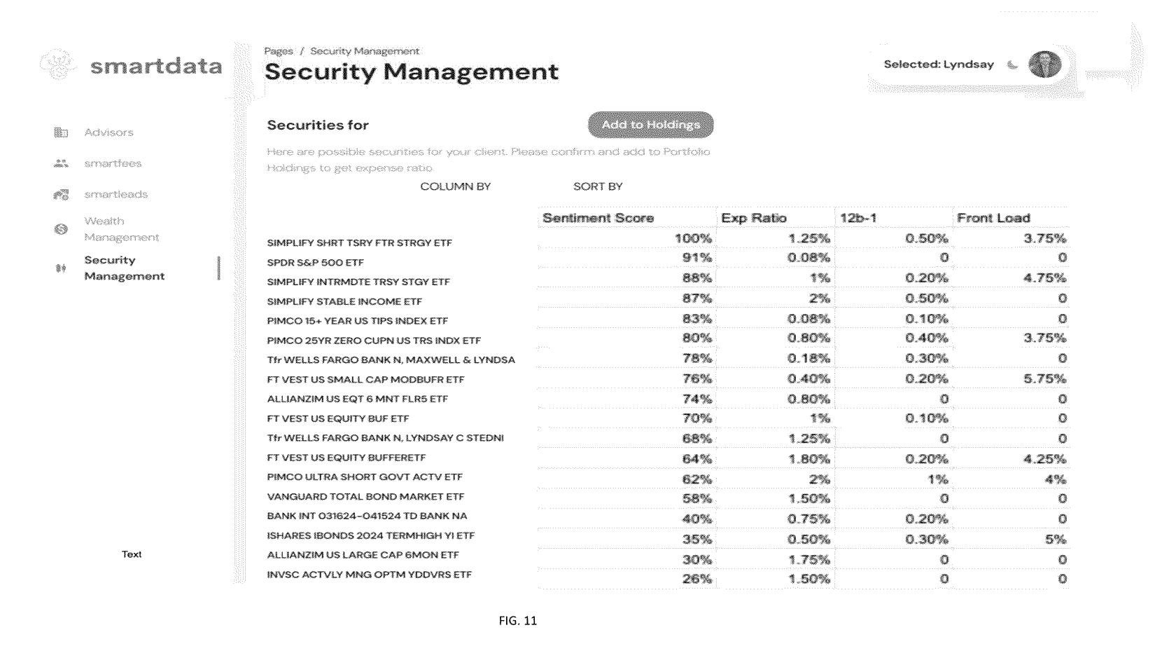

FIG. 11 shows calculated sentiment scores for a customer's selected security or fund(s) and associated fees.

The system's bank or brokerage data may comprise a plurality of offerings by a plurality of banks or brokerage firms and the associated fees. In at least one embodiment of the present disclosure, the system may provide a customer or agent a list of offerings with their respective calculated sentiment score and associated fees in response to selecting a fund or portfolio. This list may provide the customer or agent insight into finding lower-fee alternatives that approximate their desired fund or portfolio.

The information provided to the app server may be configured to update each time the customer logs into the system, update in response to a user request, or automatically or semi-automatically (periodic) update. If the automatic or semi-automatic method is used, the app server may be configured to use a webhook to automate the refresh process automatically.

The system may be configured to perform a fiduciary stress test. For comparison, a sample similar portfolio having similar holdings as the customer's existing holdings may be assembled. The fees associated with similar holdings may be obtained and reported. A sentiment score, or percent similarity of the holdings, in the similarly assembled portfolio and their projected associated fees, may be calculated and reported. This may show the customer the lowest fees available for their holdings in their portfolio based on their existing investment profile and risk tolerance.

The sentiment score may be obtained by calculating a percentage of the likeness of the holdings of a selected portfolio, such as a selected mutual fund, with available stocks and mutual funds stored in a bank or brokerage database or otherwise available. For example, a customer or agent may select mutual fund 1, comprising 25% stock B, 25% stock C, 25% stock D, and 25% stock E, for a sentiment score. Mutual fund 2 may comprise 30% stock B, 22% stock D, 29% stock E, and 19% stock F. A sentiment score of mutual fund 1 for mutual fund 2 may be calculated as 25+22+25/100 or 72%.

In another example for calculating a sentiment score, a customer or agent may select a customer's whole portfolio for a sentiment score. This sentiment score may be obtained by calculating a percentage of the likeness of the customer's whole portfolio with one or more stocks or mutual funds. For example, if a customer's portfolio includes 100 shares of mutual fund 1 and 30 shares of stock A and mutual fund 1 comprises 25% stock B, 25% stock C, 25% stock D, and 25% stock E, then a sentiment score of the customer's whole portfolio for mutual fund 1 may be calculated as 100/130 or 77%.

In at least one embodiment, the presently disclosed system is configured to find similar funds with lower fees and provide a sentiment score. For example, data may be collected by the system upon requesting an API to get information for a target fund and other funds that are desired to be compared against the target fund. Metrics may be decided upon by the user, such as weight metrics such as similar portfolios with the lowest fees, similar portfolios with the highest fees, and similar portfolios regardless of fees. In addition to being fee-based, other weighted metrics could be most similar portfolio holdings based on Environmental, Social, and Governance (ESG) sentiment scores, supply chain concerns, or other scores based on their investor questionnaire.

The data may then be normalized per the metrics across the funds to determine the likeness or comparability of the funds. For example, data points may be adjusted to provide a common scale.

A Euclidean distance of the funds to the target fund may be computed using the system to calculate a sentiment score. For example, using the metrics and the weight of the metrics, the standard formula for calculating Euclidean distance may be used to provide a calculated distance on a multi-dimensional scale. Upon the system calculating the Euclidean distance, the likeness or comparability of the funds may be sorted and ranked according to their computed Euclidean distances. Those with shorter Euclidean distances may be more similar to the target fund. The fees associated with the more similar funds may be computed with the system and displayed with their Euclidean distances, providing a comparison of fees for like and alternative funds. The fees associated with the like and alternative funds may be determined and categorized by subtracting known fees from the total fees to determine the hidden fee amounts and referencing the system's fee to define or categorize the hidden fee(s).

The system's bank or brokerage data may comprise a plurality of offerings by a plurality of banks or brokerage firms and the associated fees. In at least one embodiment of the present disclosure, the system may provide a customer or agent a list of offerings with their respective calculated sentiment score and associated fees in response to selecting a fund or portfolio for the fiduciary stress test. This list may provide the customer or agent insight into finding lower-fee alternatives that approximate their desired fund or portfolio.

The fiduciary stress test or report showing the sentiment score and associated fees of each alternative holding in the similar portfolio may be assembled for the current time, day, or any range of days. For example, the presently disclosed system may be configured to perform the fiduciary stress test for prior or future days, weeks, months, or years. This information may enable the customer to easily identify alternative sources or holdings that provide financial assets similar to their current holdings, which may have saved fees in the past or those that may save fees in the future.

The system is configured to pull data from a CRM such as Smartleads™ in at least one embodiment. For example, the system may be configured to pull and send name, email, phone, address, company, household information, and any notes from the contact. A potential customer or prospect may then receive an invite in one of two ways. There may be a link in their email to connect their account. The end user may then be directed to an API, such as Open Banking API, that may allow them to find their brokerage and enter their login information for that brokerage, for example, Fidelity™. The system may be configured so that an end user can send their data to Smartleads™. For example, OAuth, or Open Authorization, is an open-standard protocol that allows applications to securely access resources hosted by other web apps on behalf of a user, called “user permission based.”

Once the data is pulled into Smartleads™, it may be displayed by holdings, account balance, transactions, PDF download of the statement, and Smartfees™. The system may have a subsystem known as Smartfees™, which may take the holdings and then cross reference those holdings through a mapping of the system's database that may be updated daily to find the expense ratio, 12b-1 fee, and front load fee. The expense ratio is a fee paid by investors to cover the management of a mutual fund or exchange-traded fund (ETF). It's expressed as a percentage of the fund's average net assets and includes expenses like portfolio management, marketing, administration, compliance, and shareholder services. The 12b-1 fee is an annual marketing or distribution fee on a mutual fund. The 12b-1 fee is considered to be an operational expense and, as such, may be included in a fund's expense ratio. The front-load is a sales charge or commission that an investor pays upon purchase of the asset. The percentage paid for the front-end load varies among investment companies. The system may be configured to display this information for the advisor to see and show the customer. The system may also be configured to send this information to the customer.

The presently disclosed system may also be configured to help the advisor be a true fiduciary and act in the customer's best interest by showing the stock ticker of a fund or ETF that is the most similar holdings of that prospect or customer with the lowest fees. Through the fiduciary stress test, the advisor may readily show the prospect or customer the lowest fees possible they can pay while keeping the most similar holdings and risk profile.

FIG. 10 shows a main information page that may be presented to users when they login to their system account. The page is shown as being a webpage on a customer's computer, but it may be a webpage on a tablet, phone, internet appliance, set-top box, or gaming console. The information may also be presented using a dedicated application or app downloaded onto the customer's computing device.

On the left-hand side of the user interface are the general information links or buttons for selecting which customer accounts the user has set up using the system. Other options include a link for selecting the dashboard, client/bookkeeper information, and user management.

Adjacent to the general information links is the information for the customer's system advisor. The information provided may include multiple ways of contacting the advisor, including but not limited to an email address, a phone number, a messenger app account, or a video call link.

On the right-hand side of the interface is a listing of the investment accounts linked to the account. There may be a link to add, remove, or update account information.

In at least one embodiment, a user contacts an advisor using the system application to set up the customer's account. The advisor sends a link or invitation to the user to create an account. After the customer creates the account, which the advisor may verify, the customer logs in to the account for the first time. When the customer logs in for the first time, they may be instructed to connect their investment account(s) to their system account.

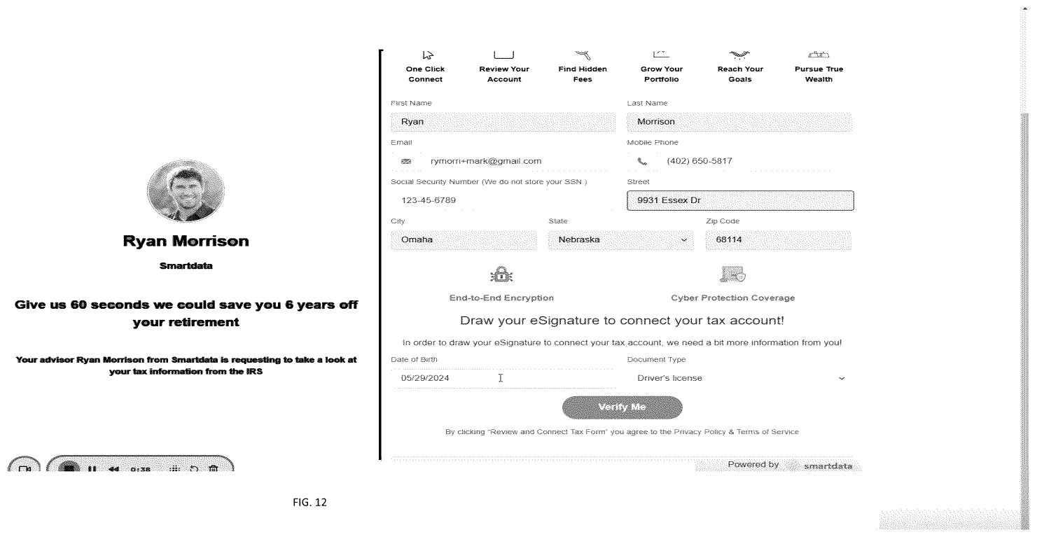

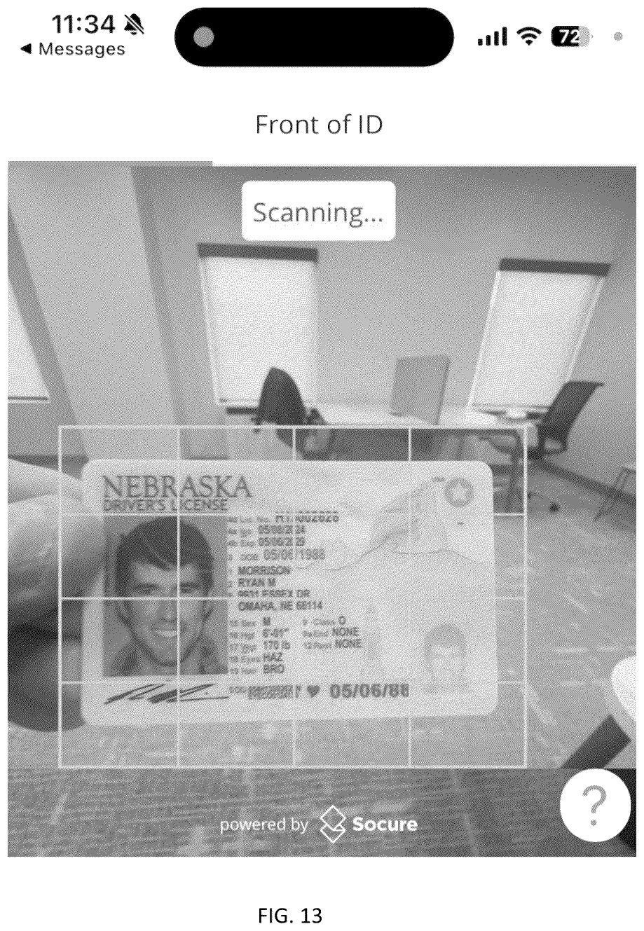

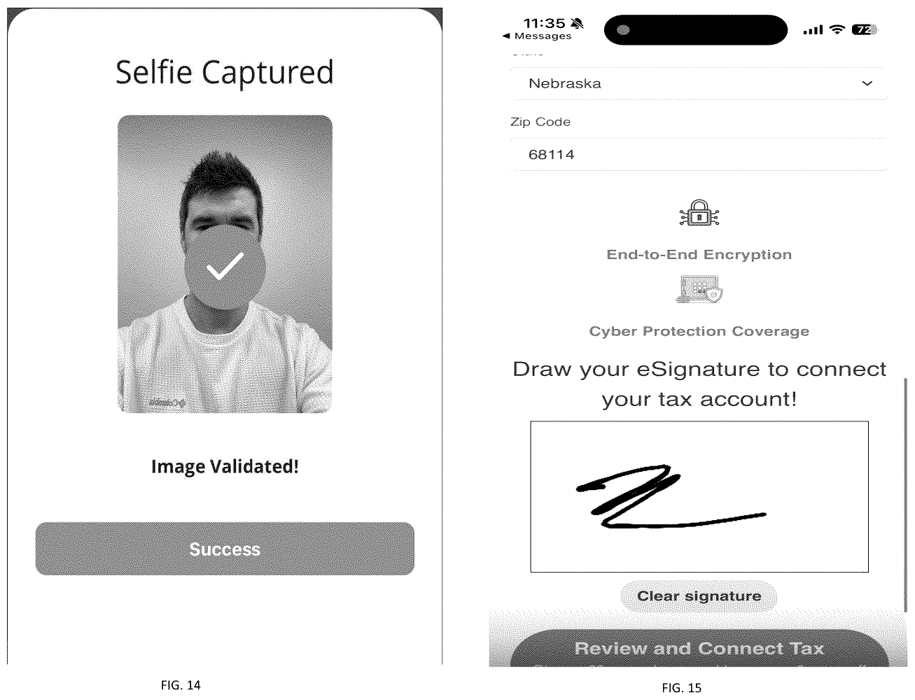

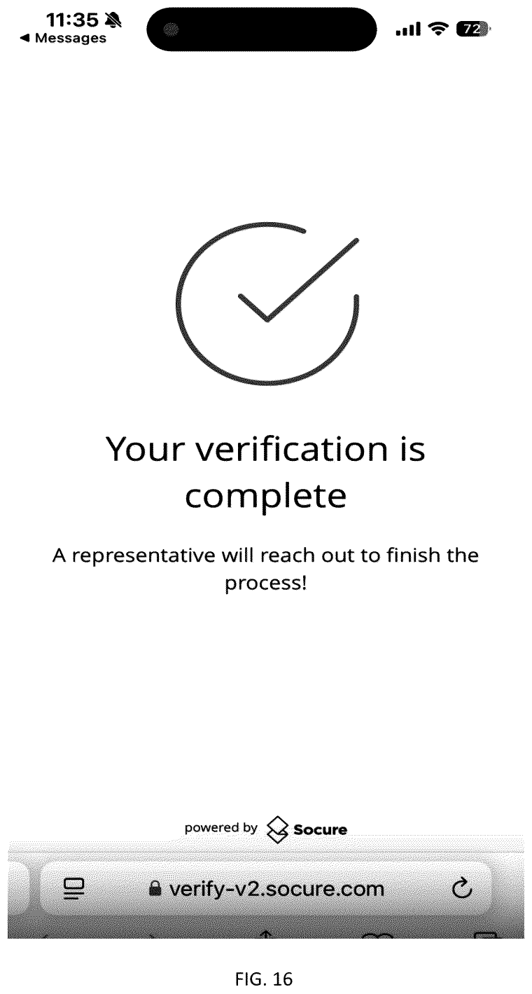

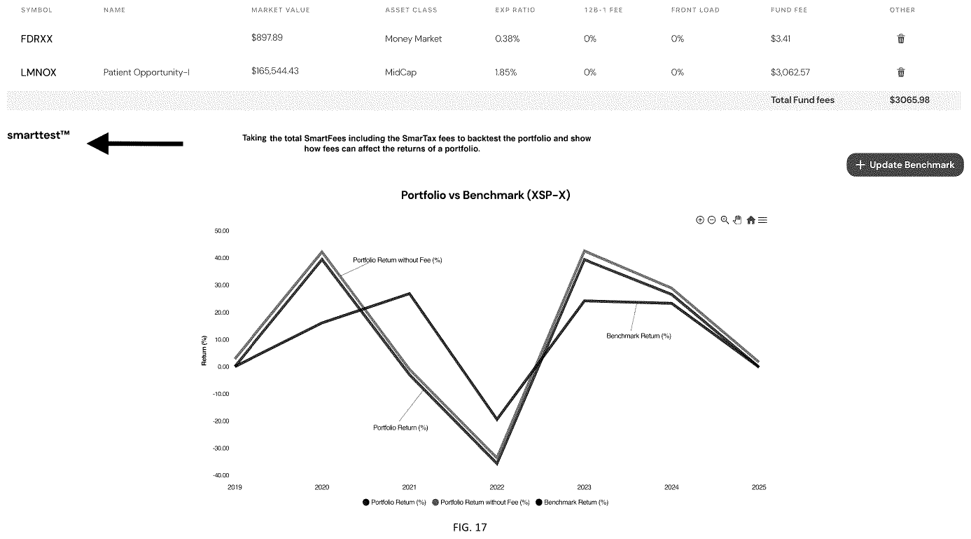

FIGS. 12-16 show steps taken by a customer or client for establishing an account and verifying their identity with the investing system. For example, a client's identity may be validated by digitally gathering an identification of the client, an image of the client, and a signature of the client, with the investing system. FIG. 12 shows the client being presented with the option to be validated by the system for the pulling of the client's tax transcript by the system. Upon selecting the validation option, the client sends a photo of themselves and the system sends a notification to the client that the photo has been successfully received and validated in FIGS. 13 and 14.

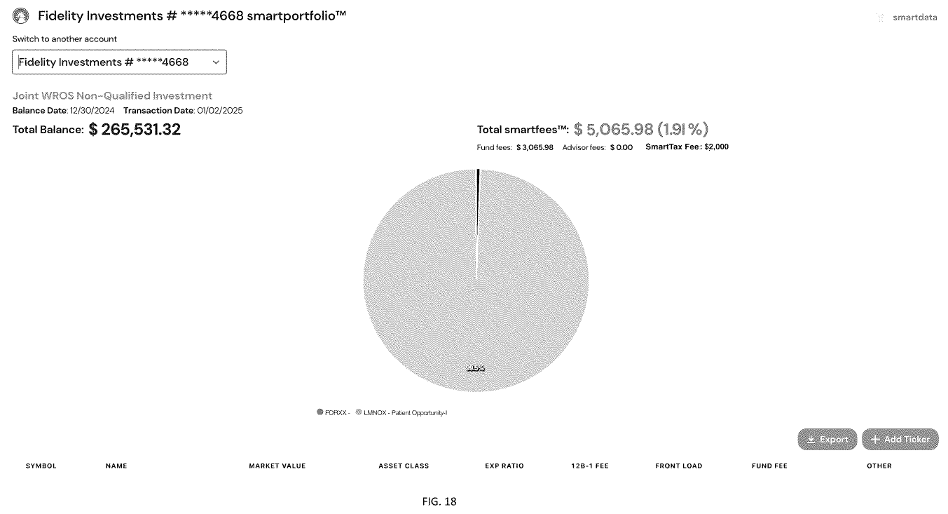

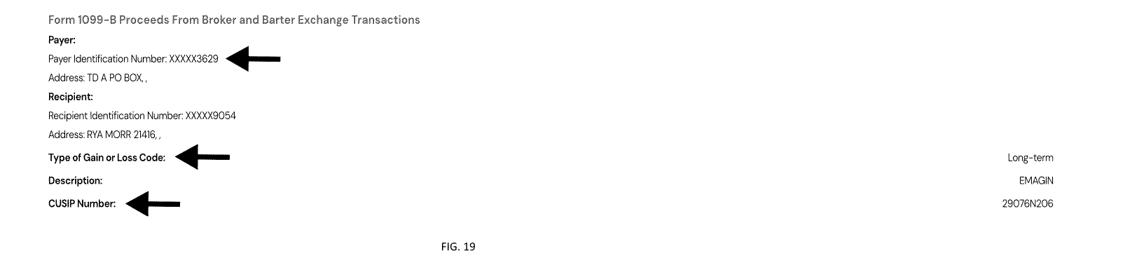

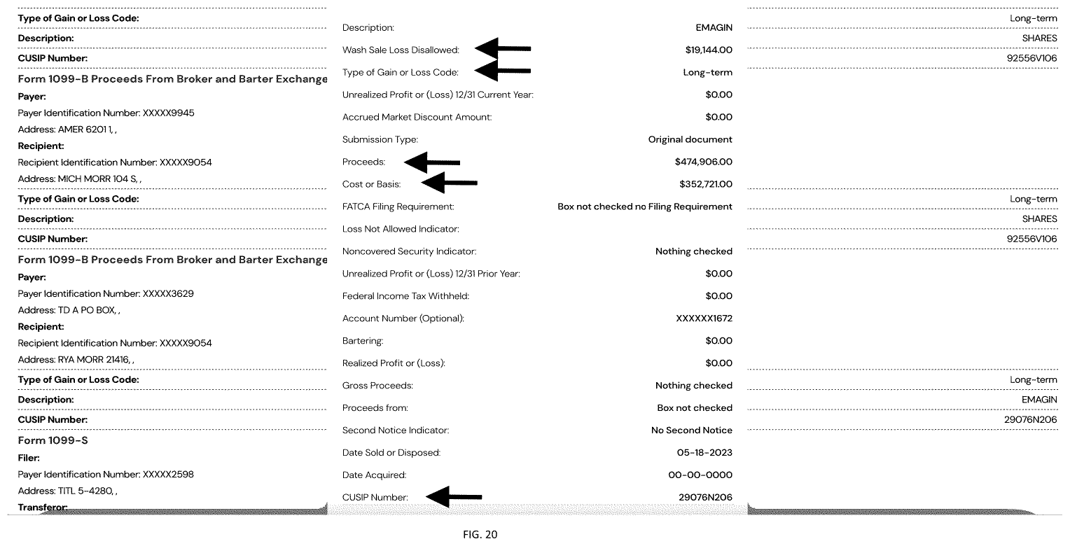

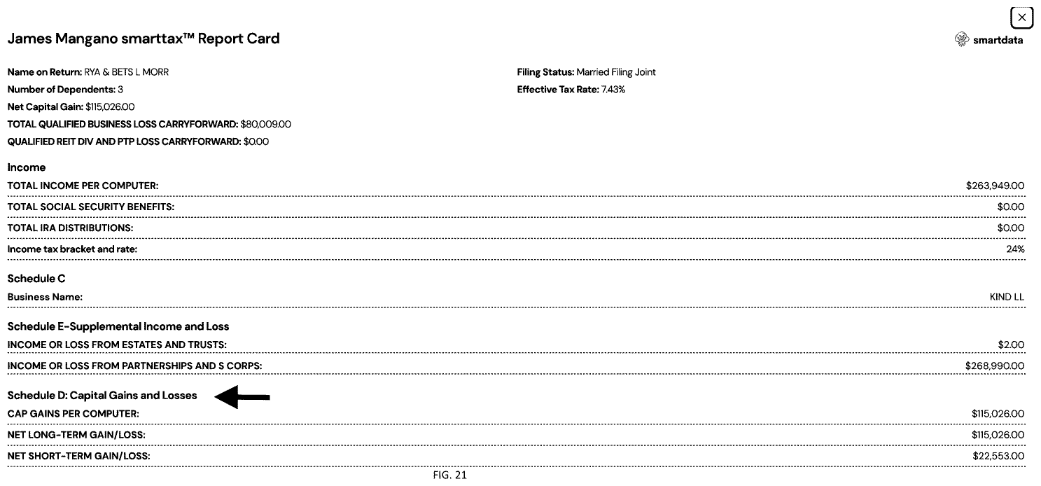

FIGS. 17-21 show a reporting to the client of the ticker symbol or CUSIP number, expense ratio, 12b-1 fee, front load fee, and the calculated capital gains tax associated with each of the ticker symbols or CUSIP numbers, by the system. For example, FIG. 18 shows a pie chart for the comparison of the capital gains tax fee with the expense ratio, 12b-1 fee, and the front load fee for a selected client holding. The fund fees may include expenses and 12b-1 fees.

There are two types of capital gains, Long (bought and sold over a year) and Short (bought and sold under a year). Short capital gains are calculated based on the customer's or client's current tax bracket based on their total income. The total income is a combined income which may include W2s or any other sources of income from partnerships, etc. Long term capital gains are gathered from a chart depending on their income which may be a 0%, 15%, or 20% gain. Below is an example chart for long term capital gains for 2024. The first column is 0%, second is 15%, and third is 20%. The SmartTax Fee calculation may be only for non-qualified accounts, therefore, the capital gains calculations may be excluded for retirement savings accounts.

Long Term Capital Gains Tax

| Status | 0% Capital Gains | 15% Capital Gains | 20% Capital Gains |
|---|---|---|---|
| Single | Up to $47,025 | $47,026-$518,900 | Over $518,900 |
| Married filing jointly | Up to $94,050 | $94,051-$583,750 | Over $583,750 |
| Married filing | Up to $47,025 | $47,026-$291,850 | Over $291,850 |
| separately | | | |
| Head of household | Up to $63,000 | $63,001-$551,350 | Over $551,350 |

A problem solved with one or more embodiments of the present disclosure is a showing or reporting of capital gains tax in addition to the reporting of other fees, such as expense ratios, 12b-1 fees, and front load fees, associated with a client's accounts or holdings. For example, many clients do not know that a retirement or brokerage account may have capital gains. Even if they know there are capital gains on their holdings, it is almost impossible to determine how capital gains have affected the fees they have paid from their portfolio.

In at least one embodiment of the present disclosure, a client's data is gathered from a brokerage account that may reside with the currently disclosed system. After identity verification, the system may gather or pull tax returns of prospective or existing clients for the client or advisor. Identity verification may obtained by the system upon a client or user signing a request. For example, the client or user sign may sign a tax request form digitally once the system has verified their SSN. The system may require the user to take a picture of their driver's license or passport and a photo or selfie. The tax request form may be sent to the IRS and their tax transcripts may be obtained with the system digitally.

Upon receipt of a client's tax transcript, capital gains tax may be calculated for each 1099 in their tax transcript. For example, proceeds minus cost or basis equals a total loss or gain (If there is a value in the Wash Sale Loss Disallowed, it is added to the total loss or gain). Using the CUSIP number a ticker symbol may be pulled from the system. A calculated gain or loss may be reported with the advisor and fund fees. For a short term gain, the calculated capital gains tax may be obtained by the system by multiplying their tax bracket, for example is 24%, with their total gain. For a long term capital gains tax, a percentage obtained from the above table, for example 15% or 20%, is multiplied by their total gain. Capital gains tax is calculated for only non-qualified accounts and not for qualified accounts such as a 401K.

### EXAMPLES

### Example 1

Short term capital tax gains tax calculation: A client buys and sells a stock in under a year for a $1,000 gain and their tax bracket is 24%. The client would owe $240 in capital gains.

### Example 2

Long term capital tax gains tax calculation: A client buys a stock and sells the stock over one year later for a $1,000 gain. The client's income is 200,000 and they filed single. The client would owe $150 in capital gains.

### Example 3

A customer transmits a portfolio of their current holdings of securities, equities, and funds to an investing system. The customer selects at least one security, equity, or fund from their current holdings. For example, as illustrated in FIG. 11, a customer selects OPPORTUNITY FUND, for analysis. The system then compares OPPORTUNITY with other available securities, equities, and funds in a database for each of the compared securities, equities, and funds in the database. The sentiment score for each of the compared securities, equities, or funds is calculated by determining a percentage of likeness with, or an inverse of a Euclidean distance from, OPPORTUNITY and the compared securities, equities, or funds in the database.

The compared securities, equities, or funds are ranked by their calculated sentiment scores. An expense ratio, a 12b-1 fee, and a front load is compiled by the system for at least an upper ranked portion of the compared securities, equities, or funds and transmitted to the customer. In the example shown in FIG. 11, seventeen other available securities, equities, and funds are listed with SPDR S&P 500 ETF, SPDR, having the highest sentiment score of 91%. The high sentiment score informs the customer that SPDR is in excess of 90% the same fund with an expense ratio of 0.08% as compared to an expense ratio of 1.25% for OPPORTUNITY. The 12b-1 fee and front load are both zero for SDR as compared to 0.5% and 2%, respectively, for OPPORTUNITY. Therefore, the customer is readily informed that SPDR is substantially a better value than their current holding of OPPORTUNITY. Therefore, it is readily shown to the customer that SPDR provides an initial savings with a front load of zero and substantial savings over time with an expense ratio of 0.08 and a 12b-1 fee of zero.

The system may be configured to calculate savings over a chosen time period. In the Example shown in FIG. 11, the difference in SDR's and OPPORTUINTY expense ratio is 1.17% (1.25-0.08) and their difference in 12b-1 fee is 0.5%. For example, the system may be configured to calculate what the customer is paying now based on their fees, or the differences in the expense ratio and 12b-1 fee. The system may also be configured to calculate what the customer would save for a 5, 10, 25, or custom year period, in the future or in the past.

### Example 4

In an illustrative example, SPDR and OPPORTUINTY are mutual funds having 91% the same holdings. A customer selects SPDR for a time period comparison of their 1,000,000 OPPORTUNITY holdings. Since the front load and 12b-1 fees are zero for SPDR, the savings for switching from OPPORTUNITY to SPDR is equal to (0.0125−0.0008+0.005)*1,000,000, or a savings of 16,700 per year.

### Example 5

In another illustrative example, Simplify Intrmdte Trsy Stgy ETF (SIMPLIFY) is selected for comparison of their 1,000,000 OPPORTUNITY holdings. SIMPLIFY and OPPORTUINTY are mutual funds having 88% the same securities or equities. SIMPLIFY's front load fee will cost 0.0475*1,000,000 or 47,500. Assuming an interest rate of 7%, the front load fee may cost 0.07*47500, or 3,325 per year. The difference in costs for the expense ratio and 12b-1 fee will be ((0.0125−0.01)+(0.005−0.002))*1,000,000, or a savings of 5,500 per year. Therefore, switching 1,000,000 from OPPORTUNITY to SIMPLIFY would result in an annual savings of 5,500-3,325, or a net savings of 2,175.

Additionally, the system may be configured to move the customer's investment to another chosen fund with a click of a button. For example, FIG. 11 shows that the customer has selected SPDR as a new fund for investing or for moving of their investment from OPPORTUNITY.

Presently disclosed is a method for investing in securities, equities, and funds comprising the steps of: receiving an invitation to join an investing system, by a customer; accepting the invitation, establishing an account with the investing system, and transmitting, or initiating a transmission of, a portfolio of current holdings of securities, equities, and funds to the system, by the customer; selecting at least one security, equity, or fund from their current holdings, by the customer; comparing the customer's selected at least one selected security, equity, or fund with other available securities, equities, and funds in a database and calculating a sentiment score for each of the compared securities, equities, and funds in the database, by the system; wherein the sentiment score for each of the compared securities, equities, and funds is calculated by determining a percentage of likeness with, or an inverse of a Euclidean distance from, the customer's selected at least one selected security, equity, or fund and the compared securities, equities, and funds in the database; ranking the compared securities, equities, and funds by their calculated sentiment scores, by the system; and compiling and transmitting, an expense ratio, a 12b-1 fee, and a front load fee associated with at least an upper ranked portion of the compared securities, equities, or funds.

Investing system 110 is configured to perform the steps of the method for investing in securities, equities, and funds steps and comprises an electronic computing device having non-transitory computer-readable medium and at least one processor, the electronic computing device is encoded with instructions for execution by the electronic computing device. System 110 has a sentiment & fee comparison engine configured and disposed for determining the percentage of likeness with, or the inverse of a Euclidean distance from, the customer's selected at least one selected security, equity, or fund and the compared securities, equities, and funds in the bank or brokerage database, a customer database configured to receive and store the customer's data and the transmitted portfolio of the customer's current holdings of securities, equities, and funds, a predictive modeling engine configured for the modeling of the cost savings of the upper ranked portion of the compared securities, equities, and funds over the period of time, and a portfolio and fee reporting engine configured for the compiling and transmitting the expense ratio, 12b-1 fee, and the front load fee.

One feature or aspect of an embodiment is believed at the time of the filing of this patent application to possibly reside broadly in a method for investing in securities, equities, and funds with an investing system comprising the steps of: gathering tax payer information of a client, with the investing system; validating an identity of the client by digitally gathering an identification of the client, an image of the client, and a signature of the client, with the investing system; pulling a tax transcript of the client, with the investing system; gathering each 1099 tax form associated with brokerage accounts or holdings of securities, equities, and funds, from the pulled tax transcript of the client, with the investing system; gathering each ticker symbol or CUSIP number from each 1099 tax form and the types and dates of the transactions associated with each ticker symbol or CUSIP number, with the investing system; determining whether each of the client's brokerage accounts or holdings of securities, equities, and funds associated with each ticker symbol or CUSIP number were held for more than one year or less than one year and determining whether the capital gains tax are long-term or short-term, with the investing system; gathering a short-term capital gains tax rate associated with a filing status of the client, for each short-term holding of brokerage accounts or holdings of securities, equities, and funds, with the investing system; calculating a short-term capital gains tax for each short-term holding by multiplying the short-term capital gains tax rate by a difference between the short-term holding and its cost basis, with the investing system; calculating a long-term capital gains tax loss or gain associated with each of the gathered 1099 tax forms by subtracting a cost basis of the long-term holding from its proceeds and adding back a loss, if the loss is subject to a disallowed wash sale, to the calculated loss or gain, for each long-term holding of brokerage accounts or holdings of securities, equities, and funds, with the investing system; calculating an expense ratio, a 12b-1 fee, and a front load fee associated with each of the holdings of brokerage accounts or holdings of securities, equities, and funds, with the investing system; and reporting the ticker symbol or CUSIP number, expense ratio, 12b-1 fee, front load fee, and the calculated capital gains tax associated with each of the ticker symbols or CUSIP numbers to the client, with the investing system.

Another feature or aspect of an embodiment is believed at the time of the filing of this patent application to possibly reside broadly in the method for investing in securities, equities, and funds, wherein the step of gathering tax payer information of the client comprises sending an invitation to join the investing system, by the investing system, receiving and accepting the invitation to join the investing system, by the client, and establishing a client account with the investing system.

Yet another feature or aspect of an embodiment is believed at the time of the filing of this patent application to possibly reside broadly in the method further comprising a step of tagging a perspective client, by an advisor, for the sending of the invitation to the client to join, by the system, prior to the step of accepting the invitation.

Still another feature or aspect of an embodiment is believed at the time of the filing of this patent application to possibly reside broadly in the method for investing in securities, equities, and funds further comprising: selecting at least one brokerage account or holding of securities, equities, and funds, by the client; comparing the client's selected at least one selected security, equity, or fund with other available securities, equities, and funds in a bank or brokerage database and calculating a sentiment score for each of the compared securities, equities, and funds in the database, by the system; wherein the calculating of the sentiment score for each of the compared securities, equities, and funds is performed by determining a percentage of likeness with, or an inverse of a Euclidean distance from, the client's selected at least one selected security, equity, or fund and the compared securities, equities, and funds in the bank or brokerage database; ranking the compared securities, equities, and funds by their calculated sentiment scores, by the system; and reporting the sentiment score for each of the ticker symbols or CUSIP numbers to the client, with the investing system.

A further feature or aspect of an embodiment is believed at the time of the filing of this patent application to possibly reside broadly in a method for investing in securities, equities, and funds comprising the steps of: receiving an invitation to join an investing system, by a client; accepting the invitation, establishing an account with the investing system, and transmitting, or initiating a transmission of, a portfolio of current holdings of securities, equities, and funds to the system, by the client; selecting at least one security, equity, or fund from their current holdings, by the client; comparing the client's selected at least one selected security, equity, or fund with other available securities, equities, and funds in a bank or brokerage database and calculating a sentiment score for each of the compared securities, equities, and funds in the database, by the system; wherein the calculating of the sentiment score for each of the compared securities, equities, and funds is performed by determining a percentage of likeness with, or an inverse of a Euclidean distance from, the client's selected at least one selected security, equity, or fund and the compared securities, equities, and funds in the bank or brokerage database; ranking the compared securities, equities, and funds by their calculated sentiment scores, by the system; and compiling and transmitting, an expense ratio, a 12b-1 fee, and a front load fee associated with at least an upper ranked portion of the compared securities, equities, and funds.

Another feature or aspect of an embodiment is believed at the time of the filing of this patent application to possibly reside broadly in the method further comprising a step of tagging a perspective client, by an advisor, for a sending of the invitation to the client to join, by the system, prior to the step of accepting the invitation.

Yet another feature or aspect of an embodiment is believed at the time of the filing of this patent application to possibly reside broadly in the method, wherein the calculating of the sentiment score for each of the compared securities, equities, and funds is performed by determining an inverse of a Euclidean distance from, the client's selected at least one selected security, equity, or fund and the compared securities, equities, and funds in the bank or brokerage database.

Still another feature or aspect of an embodiment is believed at the time of the filing of this patent application to possibly reside broadly in the method further comprising modeling of a cost savings of the upper ranked portion of the compared securities, equities, and funds over a period of time.

A further feature or aspect of an embodiment is believed at the time of the filing of this patent application to possibly reside broadly in the method of further comprising: gathering tax payer information of the client, with the investing system; validating an identity of the client by digitally gathering an identification of the client, an image of the client, and a signature of the client, with the investing system; pulling a tax transcript of the client, with the investing system; gathering each 1099 tax form associated with brokerage accounts or holdings of securities, equities, and funds, from the pulled tax transcript of the client, with the investing system; gathering each ticker symbol or CUSIP number from each 1099 tax form and the types and dates of the transactions associated with each ticker symbol or CUSIP number, with the investing system; determining whether each of the client's brokerage accounts or holdings of securities, equities, and funds associated with each ticker symbol or CUSIP number were held for more than one year or less than one year and determining whether the capital gains tax are long-term or short-term, with the investing system; gathering a short-term capital gains tax rate associated with a filing status of the client, for each short-term holding of brokerage accounts or holdings of securities, equities, and funds, with the investing system; calculating a short-term capital gains tax for each short-term holding by multiplying the short-term capital gains tax rate by a difference between the short-term holding and its cost basis, with the investing system; calculating a long-term capital gains tax loss or gain associated with each of the gathered 1099 tax forms by subtracting a cost basis of the long-term holding from its proceeds and adding back a loss, if the loss is subject to a disallowed wash sale, to the calculated loss or gain, for each long-term holding of brokerage accounts or holdings of securities, equities, and funds, with the investing system; calculating an expense ratio, a 12b-1 fee, and a front load fee associated with each of the holdings of brokerage accounts or holdings of securities, equities, and funds, with the investing system; and reporting the ticker symbol or CUSIP number, expense ratio, 12b-1 fee, front load fee, and the calculated capital gains tax associated with each of the ticker symbols or CUSIP numbers to the client, with the investing system.

Another feature or aspect of an embodiment is believed at the time of the filing of this patent application to possibly reside broadly in an investing system configured to perform the steps the steps of the method comprising: a sentiment & fee comparison engine configured and disposed for determining the percentage of likeness with, or the inverse of a Euclidean distance from, the client's selected at least one selected security, equity, or fund and the compared securities, equities, and funds in the bank or brokerage database; a client database configured to receive and store the client's data and the transmitted portfolio of the client's current holdings of securities, equities, and funds; a predictive modeling engine configured for the modeling of the cost savings of the upper ranked portion of the compared securities, equities, and funds over the period of time; and a portfolio and fee reporting engine configured for the compiling and transmitting the expense ratio, the 12b-1 fee, and the front load fee.

Yet another feature or aspect of an embodiment is believed at the time of the filing of this patent application to possibly reside broadly in an investing system configured for providing fee information associated with brokerage accounts and providing sentiment scores for alternative portfolio holdings, the system being configured for: receiving an invitation to join an investing system, by a client; accepting the invitation, establish an account with the investing system, and transmitting, or initiating a transmission of, a portfolio of current holdings of securities, equities, and funds to the system, by the client; selecting at least one security, equity, or fund from their current holdings, by the client; comparing the client's selected at least one selected security, equity, or fund with other available securities, equities, and funds in a bank or brokerage database and calculating a sentiment score for each of the compared securities, equities, and funds in the database, by the system; wherein the calculating of the sentiment score for each of the compared securities, equities, and funds is performed by determining a percentage of likeness with, or an inverse of a Euclidean distance from, the client's selected at least one selected security, equity, or fund and the compared securities, equities, and funds in the bank or brokerage database; ranking the compared securities, equities, and funds by their calculated sentiment scores, by the system; and compiling and transmitting, an expense ratio, a 12b-1 fee, and a front load fee associated with at least an upper ranked portion of the compared securities, equities, and funds.

One feature or aspect of an embodiment is believed at the time of the filing of this patent application to possibly reside broadly in the system being configured for tagging a perspective customer, by an advisor, for a sending of the invitation to the customer to join.

1. A method for investing in securities, equities, and funds with an investing system comprising the steps of:
gathering tax payer information of a client, with the investing system;
validating an identity of the client by digitally gathering an identification of the client, an image of the client, and a signature of the client, with the investing system;
pulling a tax transcript of the client, with the investing system;
gathering each 1099 tax form associated with brokerage accounts or holdings of securities, equities, and funds, from the pulled tax transcript of the client, with the investing system;
gathering each ticker symbol or CUSIP number from each 1099 tax form and the types and dates of the transactions associated with each ticker symbol or CUSIP number, with the investing system;
determining whether each of the client's brokerage accounts or holdings of securities, equities, and funds associated with each ticker symbol or CUSIP number were held for more than one year or less than one year and determining whether the capital gains tax are long-term or short-term, with the investing system;
gathering a short-term capital gains tax rate associated with a filing status of the client, for each short-term holding of brokerage accounts or holdings of securities, equities, and funds, with the investing system;
calculating a short-term capital gains tax for each short-term holding by multiplying the short-term capital gains tax rate by a difference between the short-term holding and its cost basis, with the investing system;
calculating a long-term capital gains tax loss or gain associated with each of the gathered 1099 tax forms by subtracting a cost basis of the long-term holding from its proceeds and adding back a loss, if the loss is subject to a disallowed wash sale, to the calculated loss or gain, for each long-term holding of brokerage accounts or holdings of securities, equities, and funds, with the investing system;
calculating an expense ratio, a 12b-1 fee, and a front load fee associated with each of the holdings of brokerage accounts or holdings of securities, equities, and funds, with the investing system; and
reporting the ticker symbol or CUSIP number, expense ratio, 12b-1 fee, front load fee, and the calculated capital gains tax associated with each of the ticker symbols or CUSIP numbers to the client, with the investing system.

2. The method for investing in securities, equities, and funds of claim 1, wherein the step of gathering tax payer information of the client comprises sending an invitation to join the investing system, by the investing system, receiving and accepting the invitation to join the investing system, by the client, and establishing a client account with the investing system.

3. The method for investing in securities, equities, and funds of claim 2, further comprising a step of tagging a perspective client, by an advisor, for the sending of the invitation to the client to join, by the system, prior to the step of accepting the invitation.

4. The method for investing in securities, equities, and funds of claim 1, further comprising:
selecting at least one brokerage account or holding of securities, equities, and funds, by the client;
comparing the client's selected at least one selected security, equity, or fund with other available securities, equities, and funds in a bank or brokerage database and calculating a sentiment score for each of the compared securities, equities, and funds in the database, by the system;
wherein the calculating of the sentiment score for each of the compared securities, equities, and funds is performed by determining a percentage of likeness with, or an inverse of a Euclidean distance from, the client's selected at least one selected security, equity, or fund and the compared securities, equities, and funds in the bank or brokerage database;
ranking the compared securities, equities, and funds by their calculated sentiment scores, by the system; and
reporting the sentiment score for each of the ticker symbols or CUSIP numbers to the client, with the investing system.

5. A method for investing in securities, equities, and funds comprising the steps of:
receiving an invitation to join an investing system, by a client;
accepting the invitation, establishing an account with the investing system, and transmitting, or initiating a transmission of, a portfolio of current holdings of securities, equities, and funds to the system, by the client;
selecting at least one security, equity, or fund from their current holdings, by the client;
comparing the client's selected at least one selected security, equity, or fund with other available securities, equities, and funds in a bank or brokerage database and calculating a sentiment score for each of the compared securities, equities, and funds in the database, by the system;
wherein the calculating of the sentiment score for each of the compared securities, equities, and funds is performed by determining a percentage of likeness with, or an inverse of a Euclidean distance from, the client's selected at least one selected security, equity, or fund and the compared securities, equities, and funds in the bank or brokerage database;
ranking the compared securities, equities, and funds by their calculated sentiment scores, by the system; and
compiling and transmitting, an expense ratio, a 12b-1 fee, and a front load fee associated with at least an upper ranked portion of the compared securities, equities, and funds.

6. The method for investing in securities, equities, and funds of claim 5, further comprising a step of tagging a perspective client, by an advisor, for a sending of the invitation to the client to join, by the system, prior to the step of accepting the invitation.

7. The method for investing in securities, equities, and funds of claim 5, wherein the calculating of the sentiment score for each of the compared securities, equities, and funds is performed by determining an inverse of a Euclidean distance from, the client's selected at least one selected security, equity, or fund and the compared securities, equities, and funds in the bank or brokerage database.

8. The method for investing in securities, equities, and funds of claim 5, further comprising modeling of a cost savings of the upper ranked portion of the compared securities, equities, and funds over a period of time.

9. The method for investing in securities, equities, and funds of claim 5, further comprising:
gathering tax payer information of the client, with the investing system;
validating an identity of the client by digitally gathering an identification of the client, an image of the client, and a signature of the client, with the investing system;
pulling a tax transcript of the client, with the investing system;
gathering each 1099 tax form associated with brokerage accounts or holdings of securities, equities, and funds, from the pulled tax transcript of the client, with the investing system;
gathering each ticker symbol or CUSIP number from each 1099 tax form and the types and dates of the transactions associated with each ticker symbol or CUSIP number, with the investing system;
determining whether each of the client's brokerage accounts or holdings of securities, equities, and funds associated with each ticker symbol or CUSIP number were held for more than one year or less than one year and determining whether the capital gains tax are long-term or short-term, with the investing system;
gathering a short-term capital gains tax rate associated with a filing status of the client, for each short-term holding of brokerage accounts or holdings of securities, equities, and funds, with the investing system;
calculating a short-term capital gains tax for each short-term holding by multiplying the short-term capital gains tax rate by a difference between the short-term holding and its cost basis, with the investing system;
calculating a long-term capital gains tax loss or gain associated with each of the gathered 1099 tax forms by subtracting a cost basis of the long-term holding from its proceeds and adding back a loss, if the loss is subject to a disallowed wash sale, to the calculated loss or gain, for each long-term holding of brokerage accounts or holdings of securities, equities, and funds, with the investing system;
calculating an expense ratio, a 12b-1 fee, and a front load fee associated with each of the holdings of brokerage accounts or holdings of securities, equities, and funds, with the investing system; and
reporting the ticker symbol or CUSIP number, expense ratio, 12b-1 fee, front load fee, and the calculated capital gains tax associated with each of the ticker symbols or CUSIP numbers to the client, with the investing system.

10. An investing system configured to perform the steps of claim 5 comprising:
a sentiment & fee comparison engine configured and disposed for determining the percentage of likeness with, or the inverse of a Euclidean distance from, the client's selected at least one selected security, equity, or fund and the compared securities, equities, and funds in the bank or brokerage database;
a client database configured to receive and store the client's data and the transmitted portfolio of the client's current holdings of securities, equities, and funds;
a predictive modeling engine configured for the modeling of the cost savings of the upper ranked portion of the compared securities, equities, and funds over the period of time; and
a portfolio and fee reporting engine configured for the compiling and transmitting the expense ratio, the 12b-1 fee, and the front load fee.

11. An investing system configured for providing fee information associated with brokerage accounts and providing sentiment scores for alternative portfolio holdings, the system being configured for:
receiving an invitation to join an investing system, by a client;
accepting the invitation, establish an account with the investing system, and transmitting, or initiating a transmission of, a portfolio of current holdings of securities, equities, and funds to the system, by the client;
selecting at least one security, equity, or fund from their current holdings, by the client;
comparing the client's selected at least one selected security, equity, or fund with other available securities, equities, and funds in a bank or brokerage database and calculating a sentiment score for each of the compared securities, equities, and funds in the database, by the system;
wherein the calculating of the sentiment score for each of the compared securities, equities, and funds is performed by determining a percentage of likeness with, or an inverse of a Euclidean distance from, the client's selected at least one selected security, equity, or fund and the compared securities, equities, and funds in the bank or brokerage database;
ranking the compared securities, equities, and funds by their calculated sentiment scores, by the system; and
compiling and transmitting, an expense ratio, a 12b-1 fee, and a front load fee associated with at least an upper ranked portion of the compared securities, equities, and funds.

12. The investing system of claim 11 configured for tagging a perspective customer, by an advisor, for a sending of the invitation to the customer to join.

13. The investing system of claim 11 configured for:
gathering tax payer information of a client, with the investing system;
validating an identity of the client by digitally gathering an identification of the client, an image of the client, and a signature of the client, with the investing system;
pulling a tax transcript of the client, with the investing system;
gathering each 1099 tax form associated with brokerage accounts or holdings of securities, equities, and funds, from the pulled tax transcript of the client, with the investing system;
gathering each ticker symbol or CUSIP number from each 1099 tax form and the types and dates of the transactions associated with each ticker symbol or CUSIP number, with the investing system;
determining whether each of the client's brokerage accounts or holdings of securities, equities, and funds associated with each ticker symbol or CUSIP number were held for more than one year or less than one year and determining whether the capital gains tax are long-term or short-term, with the investing system;
gathering a short-term capital gains tax rate associated with a filing status of the client, for each short-term holding of brokerage accounts or holdings of securities, equities, and funds, with the investing system;
calculating a short-term capital gains tax for each short-term holding by multiplying the short-term capital gains tax rate by a difference between the short-term holding and its cost basis, with the investing system;
calculating a long-term capital gains tax loss or gain associated with each of the gathered 1099 tax forms by subtracting a cost basis of the long-term holding from its proceeds and adding back a loss, if the loss is subject to a disallowed wash sale, to the calculated loss or gain, for each long-term holding of brokerage accounts or holdings of securities, equities, and funds, with the investing system;
calculating an expense ratio, a 12b-1 fee, and a front load fee associated with each of the holdings of brokerage accounts or holdings of securities, equities, and funds, with the investing system; and
reporting the ticker symbol or CUSIP number, expense ratio, 12b-1 fee, front load fee, and the calculated capital gains tax associated with each of the ticker symbols or CUSIP numbers to the client, with the investing system.
